(19) United States
(12) Patent Application Publication
(10) Pub. No.: US 2013/0062571 A1
(43) Pub. Date: Mar. 14, 2013

(54) METHOD FOR PREPARING ELECTRODE ACTIVE MATERIAL SLURRY AND ELECTROCHEMICAL CAPACITOR COMPRISING ELECTRODE USING ELECTRODE ACTIVE MATERIAL SLURRY PREPARED BY THE METHOD

(71) Applicants: Sang Kyun LEE, Gyeonggi-do (KR); Seung Min KIM, Seoul (KR); Ji Sung CHO, Gyeonggi-do (KR); Bae Kyun KIM, Gyeonggi-do (KR); Sergey Remizov, Gyeonggi-do (KR)

(72) Inventors: Sang Kyun LEE, Gyeonggi-do (KR); Seung Min KIM, Seoul (KR); Ji Sung CHO, Gyeonggi-do (KR); Bae Kyun KIM, Gyeonggi-do (KR); Sergey Remizov, Gyeonggi-do (KR)

(73) Assignee: Samsung Electro-Mechanics, Suwon (KR)

(21) Appl. No.: 13/570,522

(22) Filed: Aug. 9, 2012

(30) Foreign Application Priority Data
Sep. 14, 2011 (KR) 10-2011-0092588

(51) Int. Cl. H01B 1/20

(52) U.S. Cl. 252/500

(57) ABSTRACT

A method for preparing electrode active material slurry including: mixing a conductive agent and a first thickener with a low molecular weight to primarily disperse the mixture; and mixing an active material and a second thickener with a higher molecular weight than the first thickener in the primary dispersion to secondarily disperse the mixture, and an electrochemical capacitor comprising an electrode using electrode active material slurry prepared by the method. It is possible to prepare a low resistance and high capacity electrochemical capacitor by selectively using at least two thickeners with different degrees of polymerization and molecular weights to remarkably improve dispersibility of an active material and a conductive agent. Particularly, it is possible to reduce resistance based on an electrochemical capacitor with the same capacity.

### CROSS-REFERENCE TO RELATED APPLICATIONS

Claim and incorporate by reference domestic priority application and foreign priority application as follows:

### CROSS REFERENCE TO RELATED APPLICATION

This application claims the benefit under 35 U.S.C. Section 119 of Korean Patent Application Serial No. 10-2011-0092588, entitled filed Sep. 14, 2011, which is hereby incorporated by reference in its entirety into this application.

### BACKGROUND OF THE INVENTION

1. Field of the Invention

The present invention relates to a method for preparing electrode active material slurry and an electrochemical capacitor comprising an electrode using electrode active material slurry prepared by the method.

2. Description of the Related Art

An electric double layer capacitor (EDLC), which is an energy storage device with remarkably large capacity compared to a condenser or an electrolytic capacitor, is called a supercapacitor or an ultracapacitor. The EDLC, a power source which gathers much energy and discharges high energy for several tens of seconds or several minutes, is a useful component capable of filling a performance characteristic region where existing condenser and secondary battery can not accommodate.

An operation principle and a basic structure of the EDLC are as shown in FIG. 1. Referring to this, the EDLC consists of a current collector 10, an electrode 20, an electrolyte 30, and a separator 40.

The electrode 20 consists of an active material with a large effective specific surface area such as activated carbon powder or activated carbon fibers, a conductive agent for giving conductivity, and a binder for adhesion between components. Further, the electrode 20 consists of a cathode 21 and an anode 22 with the separator interposed therebetween.

Further, the electrolyte 30 is an aqueous electrolyte or a non-aqueous (organic) electrolyte.

The separator 40 is polypropylene or Teflon and plays a role of preventing a short due to contact between the cathode 21 and the anode 22.

The EDLC uses a principle that electrolytic ions 31a and 31b dissociated on surfaces of the respective cathode 21 and the anode 22 are physically adsorbed on the opposite electrode to accumulate electricity when a voltage is applied during charging and the ions of the cathode 21 and the anode 22 are desorbed from the electrode to be returned to a neutralized state.

Meanwhile, an electrode typically used in the EDLC includes an active material, a conductive agent for improving conductivity, a binder, and so on. As can be checked from a particle shape through a scanning electron microscope in the following FIG. 2, since the active material has a bulk shape with a particle size of greater than 10 μm, it has difficulty in packing and very low conductivity.

Therefore, the conductive agent is added to improve conductivity. As can be checked from a particle shape through a scanning electron microscope in the following FIG. 3, the conductive agent used at this time has a particle size of just several tens of nm. That is, since a difference in particle size between the active material and the conductive agent is very significant, there is a problem of non-uniform dispersion in preparing active material slurry for electrode formation.

Generally, a great quantity of conductive agent is additionally added to improve conductivity of the product particularly requiring high output characteristics among the EDLC products. However, in some cases, when more than an adequate level of conductive agent is added, there is little change in resistance characteristics but a reduction in capacity characteristics.

Generally, an EDLC electrode consists of an active material, a conductive agent, a binder for bonding an active material, and a binder for bonding with a current collector.

Further, preparation of the electrode consists of \hat{1} dry mixing process of the above components, \hat{2} granulating process, \hat{3} kneading process, \hat{4} slurry process, and \hat{5} current collector coating process.

However, since a difference in particle size between the active material and the conductive agent, which constitute the electrode, is several hundred times, it is impossible to achieve uniform dispersion of the particles through the above processes.

Consequently, there is no choice but to prepare active material slurry as in the following FIG. 4. That is, it is impossible to achieve uniform dispersion due to agglomeration of active materials 50 with a large particle size, agglomeration of conductive agents 60 with a relatively small particle size, or secondary agglomeration of the conductive agents 60 by the added binder 70.

Due to these reasons, although the amount of the conductive agent is increased to improve conductivity, there is a limit to improvement of resistance characteristics.

### SUMMARY OF THE INVENTION

The present invention has been invented in order to overcome the above-described problems and it is, therefore, an object of the present invention to provide a method for preparing electrode active material slurry capable of uniformly dispersing an active material and a conductive agent with different particle sizes.

Further, it is another object of the present invention to provide an electrochemical capacitor comprising an electrode using electrode active material slurry.

In accordance with one aspect of the present invention to achieve the object, there is provided a method for preparing electrode active material slurry including: mixing a conductive agent and a first thickener with a low molecular weight to primarily disperse the mixture; and mixing an active material and a second thickener with a higher molecular weight than the first thickener in the primary dispersion to secondarily disperse the mixture.

Further, in accordance with another embodiment of the present invention, there is provided a method for preparing electrode active material slurry including: a first step of mixing a conductive agent and a first thickener with a low molecular weight to primarily disperse the mixture; a second step of mixing an active material and a second thickener with a high molecular weight to secondarily disperse the mixture; and mixing the dispersions of the first step and the second step to tertiarily disperse the mixture.

The first thickener with a low molecular weight may have a degree of polymerization of 100 to 250 and a weight average molecular weight of 20,000 to 55,000.

Further, the second thickener with a higher molecular weight than the first thickener may have a degree of polymerization of 251 to 1,200 and a weight average molecular weight of 56,000 to 250,000.

The first thickener with a low molecular weight and the second thickener with a high molecular weight may be at least one selected from the group consisting of carboxymethyl cellulose (CMC), polyvinyl alcohol (PVA), polyvinyl butyral (PVB), poly N-vinylacetamide (PNVA), styrene-butadiene rubber (SBR), acrylic resins, and fluorine resins.

Further, the present invention may provide an electrochemical capacitor comprising an electrode using electrode active material slurry prepared by each of the above preparation methods.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view showing a basic structure and an operation principle of a typical electric double layer capacitor;

FIG. 2 is a scanning electron microscope photograph of active material particles;

FIG. 3 is a scanning electron microscope photograph of conductive agent particles;

FIG. 4 is a view showing agglomeration between an active material and a conductive agent in preparing active material slurry in accordance with a conventional method; and

FIG. 5 is a view showing uniform dispersion of an active material and a conductive agent in preparing active material slurry in accordance with a method of the present invention.

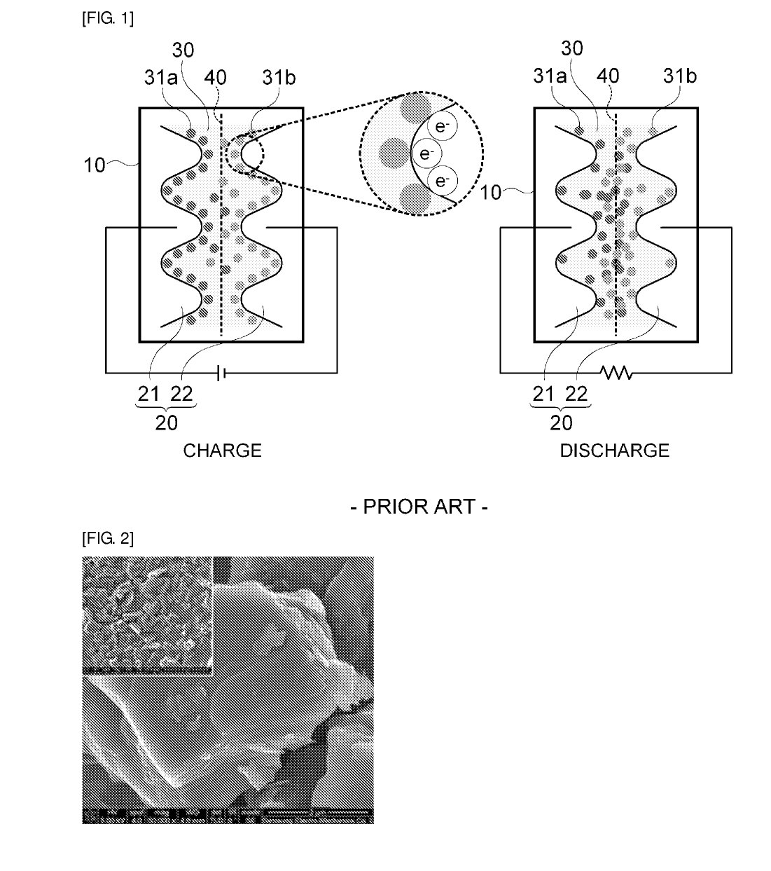

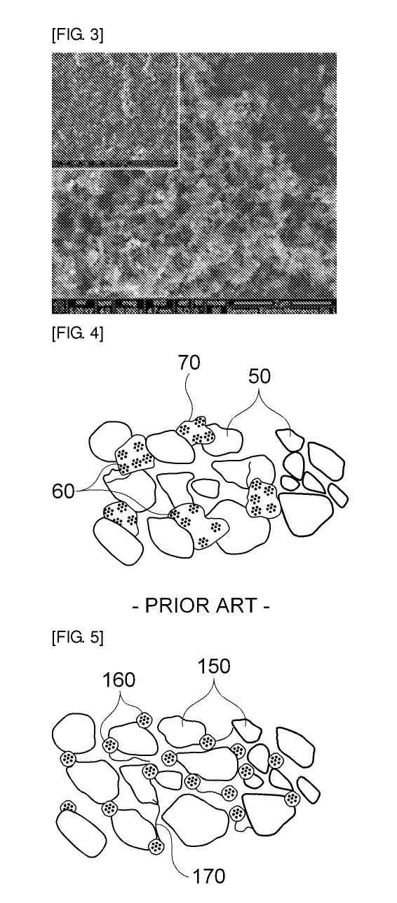

### DETAILED DESCRIPTION OF THE PREFERABLE EMBODIMENTS

Hereinafter, the present invention will be described in detail.

Terms used herein are provided to explain embodiments, not limiting the present invention. Throughout this specification, the singular form includes the plural form unless the context clearly indicates otherwise. Further, terms “comprises” and/or “comprising” used herein specify the existence of described shapes, numbers, steps, operations, members, elements, and/or groups thereof, but do not preclude the existence or addition of one or more other shapes, numbers, operations, members, elements, and/or groups thereof.

The present invention relates to a method for preparing electrode active material slurry and an electrochemical capacitor comprising an electrode using electrode active material slurry prepared by the method.

A method for preparing electrode active material slurry in accordance with the present invention is to effectively disperse an active material and a conductive agent with different particle sizes. Therefore, it is possible to prepare active material slurry with high dispersibility by using two or more thickeners with different molecular weights suitable for the particle sizes of the active material and the conductive agent or specifying input time of the thickeners.

A method for preparing electrode active material slurry in accordance with a first embodiment of the present invention includes the steps of mixing a conductive agent and a first thickener with a low molecular weight to primarily disperse the mixture and mixing an active material and a second thickener with a higher molecular weight than the first thickener in the primary dispersion to secondarily disperse the mixture.

First, the first step is a step of completely dispersing the conductive agent by mixing the first thickener with a relatively low molecular weight in the conductive agent. It is preferred that the conductive agent is maintained in a state in which a shear stress is applied by a mechanical stirrer and so on before being mixed with the first thickener. Therefore, when the first thickener with a low molecular weight is added to the conductive agent being stirred, it is possible to completely disperse the conductive agent by maintaining a dispersion state.

It is preferable to use a thickener with a low degree of polymerization and a low molecular weight for the primary dispersion of only the conductive agent, and it is preferred that the first thickener with a low molecular weight used at this time has a degree of polymerization (DP) of 100 to 250 and a weight average molecular weight of 20,000 to 55,000.

When the degree of polymerization of the first thickener is less than 10, it is not preferred since there is a problem with serving as a thickener due to very low viscosity. Further, when the degree of polymerization of the first thickener exceeds 250, it is not preferred since there is a problem with dispersion due to high viscosity.

Further, when the weight average molecular weight of the first thickener is less than 20,000, it is not preferred since there is a problem with serving as a thickener due to very low viscosity. Further, when the weight average molecular weight of the first thickener exceeds 55,000, it is not preferred since there is a problem with dispersion due to high viscosity.

For a concrete example, the first thickener with a low molecular weight may be one selected from the group consisting of carboxymethyl cellulose (CMC), polyvinyl alcohol (PVA), polyvinyl butyral (PVB), poly N-vinylacetamide (PNVA), styrene-butadiene rubber (SBR), acrylic resins (for example, acrylic acid), and fluorine resins (for example, PTFE, PVDF) but not limited thereto.

Among them, CMC has a structure in which molecular chains are entangled and a shear thinning tendency that viscosity is high when shear speed is low and the viscosity is reduced in proportion to the shear speed when the shear speed is high. Therefore, the CMC thickener of which a level of entanglement is lowered or low viscosity CMC can be more preferably used in primarily dispersing the conductive agent.

The next step is a step of mixing the active material with a relatively large particle size and the second thickener with a higher molecular weight than the first thickener in the dispersion in which the primarily dispersed conductive agent and first thickener are mixed and secondarily dispersing the mixture.

The low viscosity thickener with a low molecular weight used in the dispersion of the conductive agent is not suitable for dispersion of the active material with a relatively large particle size. Therefore, in secondarily dispersing the active material, the second thickener with a high degree of polymerization and a high molecular weight compared to the first thickener used in the dispersion of the conductive agent is required.

It is preferred that the second thickener with a higher molecular weight than the first thickener has a degree of polymerization (DP) of 251 to 1,200 and a weight average molecular weight of 56,000 to 250,000.

When the degree of polymerization of the second thickener is less than 251, it is not preferred since there is a problem with serving as a thickener due to very low viscosity. Further, when the degree of polymerization of the second thickener exceeds 1,200, it is not preferred since there is a problem with dispersion due to high viscosity.

Further, when the weight average molecular weight of the second thickener is less than 56,000, it is not preferred since there is a problem with serving as a thickener due to very low viscosity. Further, when the weight average molecular weight of the second thickener exceeds 250,000, it is not preferred since there is a problem with dispersion due to high viscosity.

The second thickener with a high molecular weight also may use the same material as the first thickener or a material with different degree of polymerization and molecular weight from the first thickener.

The above method does not have a problem such as agglomeration between the conductive agents or between the active materials as in the conventional method by mixing the active material and the thickener with a high molecular weight in the primarily dispersed conductive agent and secondarily dispersing the mixture.

That is, as in the following FIG. 5, although a difference in particle size between an active material 150 and a conductive agent 160 is several hundred times, it is possible to obtain an effect of uniform dispersion by primarily dispersing the conductive agent 160 using a first thickener with a low molecular weight and adding the active material 150 and a second thickener 170 with a high molecular weight to the primary dispersion to secondarily disperse the mixture.

Therefore, the agglomerated conductive agent 160 with a relatively small particle size is well dispersed by the first thickener, and the second thickener 170 with a high molecular weight is uniformly distributed between the active material 150 and the conductive agent 160 to improve a dispersion effect.

The electrode active material included in the electrode active material slurry in accordance with the present invention may be preferably activated carbon but not limited thereto. Further, it is preferred that the activated carbon has a porous structure with a specific surface area of 1,500 to 2,500 m²/g and a particle size of 5 to 20 μm but not limited thereto.

Further, the conductive agent included in the electrode active material slurry in accordance with the present invention may be one selected from the group consisting of acetylene black, carbon black, ketjen black, carbon nanotube, and carbon nanofiber but not limited thereto.

Meanwhile, a method for preparing electrode active material slurry in accordance with a second embodiment of the present invention may include the steps of mixing an active material and a second thickener with a high molecular weight to primarily disperse the mixture and mixing a conductive agent and a first thickener with a low molecular weight in the primary dispersion to secondarily disperse the mixture.

An important thing in preparing the electrode active material slurry of the present invention is to use the thickeners with different viscosities and molecular weights according to the particle sizes of the active material and the conductive agent.

Therefore, the method in accordance with the second embodiment of the present invention disperses the mixture of the active material with a relatively large particle size and the second thickener with a high molecular weight first and disperses the mixture of the dispersion, the conductive agent with a relatively smaller particle size than the active material, and the first thickener with a low molecular weight.

That is, the method in accordance with the second embodiment prepares electrode active material slurry by changing the order of the first step and the second step in the method of the first embodiment.

Therefore, the active material, the conductive agent, the first thickener, and the second thickener used in the method of the second embodiment are the same as those used in the first embodiment. However, since the method of the second embodiment disperses the active material with a large particle size first and disperses the mixture of the dispersion and the conductive agent with a small particle size, dispersibility of the electrode active material slurry of the second embodiment may be slightly low compared to the electrode active material slurry of the first embodiment, but it is negligible.

Further, a method for preparing electrode active material slurry in accordance with a third embodiment of the present invention may include a first step of mixing a conductive agent and a first thickener with a low molecular weight to primarily disperse the mixture, a second step of mixing an active material and a second thickener with a high molecular weight to secondarily disperse the mixture, and a third step of mixing the dispersions of the first step and the second step to tertiarily disperse the mixture.

In accordance with the method of the third embodiment, after the conductive agent and the active material are dispersed in separate vessels by putting the first thickener and the second thickener therein, respectively, the dispersions are mixed to be dispersed.

In accordance with the method of the third embodiment, the mixture of the conductive agent and the first thickener may be dispersed first or the mixture of the activate material and the second thickener may be dispersed first and the order is not particularly limited. However, it is important to use the thickeners with different viscosities and molecular weights according to the particle sizes of the active material and the conductive agent.

Therefore, the active material, the conductive agent, the first thickener, and the second thickener used in the method of the third embodiment are the same as those used in the first embodiment.

Further, appropriate solvents and additives may be included in the electrode active material slurry of the present invention under the condition that does not deteriorate dispersibility of the electrode active material slurry, but the kind thereof is not particularly limited.

Further, the present invention may provide an electrochemical capacitor including an electrode using electrode active material slurry prepared by the methods of the first to third embodiments.

The electrode in accordance with the present invention may be used as both of a cathode and an anode.

Further, the electrochemical capacitor may be preferably used in an electric double layer capacitor but not particularly limited thereto.

Further, a current collector, an electrolyte, a separator, and so on, which constitute the electrochemical capacitor of the present invention, are not particularly limited, and those used in electrochemical capacitors such as a typical electric double layer capacitor can be used and detailed description thereof will be omitted.

Hereinafter, preferred embodiments of the present invention will be described in detail. The following embodiments merely illustrate the present invention, and it should not be interpreted that the scope of the present invention is limited to the following embodiments. Further, although certain compounds are used in the following embodiments, it is apparent to those skilled in the art that equal or similar effects are shown even when using their equivalents.

### Embodiment 1

### Preparation of Electrode Active Material Slurry

CMC (degree of polymerization 100 to 250, weight average molecular weight 20,000 to 35,000) 20 g as a first thickener is put in acetylene black 100 g with a particle size of several tens of nm, which is being stirred by a mechanical stirrer, and stirred for 60 minutes to be primarily dispersed.

The primary dispersion, activated carbon (specific surface area 2000 m²/g, particle size 10 μm), and CMC (degree of polymerization 400 to 500, weight average molecular weight 100,000 to 110,000) 10 g as a second thickener are put in an aqueous solvent and stirred for 60 minutes to be secondarily dispersed so that electrode active material slurry is prepared.

### Embodiment 2

### Preparation of Electrode Active Material Slurry

Activated carbon (specific surface area 2000 m²/g, particle size 10 μm) and PVB (degree of polymerization 1000, weight average molecular weight 80,000 to 150,000) 10 g as a second thickener are put in an aqueous solvent and stirred for 60 minutes to be primarily dispersed.

Acetylene black 100 g with a particle size of several tens of nm and CMC (degree of polymerization 100 to 250, weight average molecular weight 20,000 to 35,000) 20 g as a first thickener are put in the primary dispersion, which is being stirred by a mechanical stirrer, and stirred for 60 minutes to be secondarily dispersed so that electrode active material slurry is prepared.

### Embodiment 3

### Preparation of Electrode Active Material Slurry

CMC (degree of polymerization 100 to 250, weight average molecular weight 20,000 to 35,000) 20 g as a first thickener is put in acetylene black 100 g with a particle size of several tens of nm, which is being stirred by a mechanical stirrer, and stirred for 60 minutes to be primarily dispersed.

Activated carbon (specific surface area 2000 m²/g, particle size 10 μm) and PVB (degree of polymerization 700, weight average molecular weight 50,000 to 80,000) 10 g as a second thickener are put in an aqueous solvent and stirred for 60 minutes to be secondarily dispersed.

The primary dispersion and the secondary dispersion are mixed and dispersed to prepare electrode active material slurry.

### Comparative Example 1

Activated carbon (specific surface area 2000 m²/g, particle size 10 μm), acetylene black with a particle size of 50 nm as a conductive agent, and CMC (degree of polymerization 400 to 500, weight average molecular weight 100,000 to 110,000) 10 g are put in an aqueous solvent and mixed and stirred for 60 minutes so that electrode active material slurry is prepared.

### Embodiments 4 to 6, Comparative Example 2

### Preparation of Electrochemical Capacitor

1) Preparation of Electrode

Electrode active material slurry in accordance with the embodiments 1 to 3 and the comparative example 1 is coated on a copper foil with a thickness of 10 μm by a doctor blade method, temporarily dried, and cut to an electrode size of 100 mm×100 mm. A thickness of the electrode is about 20 to 40 μm. Before assembly of a cell, the electrode is dried in a vacuum at 120° C. for 5 hours.

2) Preparation of Electrolyte

An electrolyte is prepared by dissolving a spiro salt in a mixture of a polycarbonate solvent and an acrylonitrile solvent so that concentration of the spiro salt is 1.2 mol/L.

3) Assembly of Capacitor Cell

The prepared cathode and anode are immersed in the electrolyte with a separator (polypropylene nonwoven) interposed therebetween and put in a laminate film case to be sealed. The completed cell is left as it is until measurement for about a day.

### Experimental Example

### Estimation of Capacity of Electrochemical Capacitor Cell

Capacity is measured by charging a cell to 2.5V at a constant current and a constant voltage for 900 seconds and discharging the cell at a constant current under the condition of a constant temperature of 25° C., and measurement results are shown in the following table 1.

Further, resistance characteristics of each cell are measured by an AC resistance measuring instrument, and measurement results are shown in the following table 1.

TABLE 1

| Classification | Initial Capacity (F.) | Resistance (AC ESR, Ω) |
|---|---|---|
| Comparative Example 2 | 1100 | 0.611 |
| Embodiment 4 | 1150 | 0.458 |
| Embodiment 5 | 1110 | 0.543 |
| Embodiment 6 | 1160 | 0.512 |

As in the results of the table 1, capacity of the comparative example 2, which is an electrochemical capacitor (EDLC cell) including an electrode using electrode active material slurry prepared by putting an electrode active material, a conductive agent, and a thickener all together like a common method, is 1100 F and at this time, a resistance value is 0.611 Ω.

On the other hand, capacity of an electrochemical capacitor (EDLC cell) including an electrode using electrode active material slurry prepared by adding thickeners with adjusted viscosities and molecular weights at different times like the present invention is increased and a resistance value thereof is effectively reduced.

From these results, it is possible to check that electrode active material slurry with improved dispersibility can be prepared by separately adding at least two thickeners with adjusted viscosities and molecular weights. Further, it is possible to increase capacity and effectively reduce electrical resistance when using the electrode active material slurry in an electrode of an electrochemical capacitor such as an electric double layer capacitor by improving the dispersibility of the electrode active material slurry.

According to the present invention, it is possible to prepare a low resistance and high capacity electrochemical capacitor by selectively using at least two thickeners with different degrees of polymerization and molecular weights to remarkably improve dispersibility of an active material and a conductive agent. Particularly, it is possible to reduce resistance based on an electrochemical capacitor with the same capacity.

1. A method for preparing electrode active material slurry comprising:
mixing a conductive agent and a first thickener with a low molecular weight to primarily disperse the mixture; and
mixing an active material and a second thickener with a higher molecular weight than the first thickener in the primary dispersion to secondarily disperse the mixture.

2. A method for preparing electrode active material slurry comprising:
mixing an active material and a second thickener with a high molecular weight to primarily disperse the mixture; and
mixing a conductive agent and a first thickener with a low molecular weight in the primary dispersion to secondarily disperse the mixture.

3. A method for preparing electrode active material slurry comprising:
mixing a conductive agent and a first thickener with a low molecular weight to primarily disperse the mixture;
mixing an active material and a second thickener with a high molecular weight to secondarily disperse the mixture; and
mixing the dispersions of the mixing a conductive agent and a first thickener and the mixing an active material and a second thickener to tertiarily disperse the mixture.

4. The method for preparing electrode active material slurry according to claim 1, wherein the first thickener with a low molecular weight has a degree of polymerization of 100 to 250 and a weight average molecular weight of 20,000 to 55,000.

5. The method for preparing electrode active material slurry according to claim 2, wherein the first thickener with a low molecular weight has a degree of polymerization of 100 to 250 and a weight average molecular weight of 20,000 to 55,000.

6. The method for preparing electrode active material slurry according to claim 3, wherein the first thickener with a low molecular weight has a degree of polymerization of 100 to 250 and a weight average molecular weight of 20,000 to 55,000.

7. The method for preparing electrode active material slurry according to claim 1, wherein the second thickener with a higher molecular weight than the first thickener has a degree of polymerization of 251 to 1,200 and a weight average molecular weight of 56,000 to 250,000.

8. The method for preparing electrode active material slurry according to claim 2, wherein the second thickener with a higher molecular weight than the first thickener has a degree of polymerization of 251 to 1,200 and a weight average molecular weight of 56,000 to 250,000.

9. The method for preparing electrode active material slurry according to claim 3, wherein the second thickener with a higher molecular weight than the first thickener has a degree of polymerization of 251 to 1,200 and a weight average molecular weight of 56,000 to 250,000.

10. The method for preparing electrode active material slurry according to claim 1, wherein the first thickener with a low molecular weight is one selected from the group consisting of carboxymethyl cellulose (CMC), polyvinyl alcohol (PVA), polyvinyl butyral (PVB), poly N-vinylacetamide (PNVA), styrene-butadiene rubber (SBR), acrylic resins, and fluorine resins.

11. The method for preparing electrode active material slurry according to claim 1, wherein the second thickener with a high molecular weight is one selected from the group consisting of carboxymethyl cellulose (CMC), polyvinyl alcohol (PVA), polyvinyl butyral (PVB), poly N-vinylacetamide (PNVA), styrene-butadiene rubber (SBR), acrylic resins, and fluorine resins.

12. An electrochemical capacitor comprising an electrode using electrode active material slurry according to claim 1.

13. An electrochemical capacitor comprising an electrode using electrode active material slurry according to claim 2.

14. An electrochemical capacitor comprising an electrode using electrode active material slurry according to claim 3.
